(19) United States
(12) Patent Application Publication
(10) Pub. No.: US 2015/0051944 A1
(43) Pub. Date: Feb. 19, 2015

(54) Conveyance Planning Using Dartboard Network

(71) Applicant: Regents of the University of Minnesota, St. Paul, MN (US)

(72) Inventors: Shashi Shekhar, Plymouth, MN (US); KwangSoo Yang, Minneapolis, MN (US); Venkata Maruti Viswanath Gunturi, Minneapolis, MN (US)

(21) Appl. No.: 14/391,124

(22) PCT Filed: Mar. 14, 2013
(86) PCT No.: PCT/US2013/031478

§ 371 Date: Oct. 7, 2014

Related U.S. Application Data
(60) Provisional application No. 61/648,824, filed on May 18, 2012.

(51) Int. Cl. G06Q 10/06; H04L 12/733

(52) U.S. Cl. CPC G06Q 10/06316; H04L 45/122
USPC 705/7.26

(57) ABSTRACT

A processor constructs a shortest forest of paths between a set of destination nodes and a set of source nodes, each path passing through a same number of intermediate nodes. The processor selects a set of node-independent paths from the shortest forest of paths such that no two node-independent paths pass through a same node other than a source node or a destination node of the node-independent paths. The processor uses the node-independent paths to schedule movement of items from at least one source node in the set of source nodes to at least one destination node in the set of destination nodes.

### BACKGROUND

Conveyance is the transporting or transmission of items such as people, products or data packets. Conveyance typically involves moving an item from a source to a destination across a network that has a limited number of paths, with each path having a limited amount of capacity. In general, the number of computations needed to find the optimal combination of paths to use and the optimal timing of when to send items along the network grows exponentially with the number of paths in the network and the number of items to be conveyed. For very large networks and/or very large numbers of items, finding the optimal paths and conveyance times becomes computationally intractable such that with present-day computing power it is not feasible to identify the optimal paths and scheduling.

The discussion above is merely provided for general background information and is not intended to be used as an aid in determining the scope of the claimed subject matter. The claimed subject matter is not limited to implementations that solve any or all disadvantages noted in the background.

### SUMMARY

A processor constructs a shortest forest of paths between a set of destination nodes and a set of source nodes, each path passing through a same number of intermediate nodes. The processor selects a set of node-independent paths from the shortest forest of paths such that no two node-independent paths pass through a same node other than a source node or a destination node of the node-independent paths. The processor uses the node-independent paths to schedule movement of items from at least one source node in the set of source nodes to at least one destination node in the set of destination nodes.

The set of source nodes and destination nodes comprise computing devices and the items comprise data packets in accordance with one embodiment. In accordance with a separate embodiment, the paths comprise travel routes for people.

After scheduling movement of items from at least one source node in the set of source nodes to at least one destination node in the set of destination nodes, the processor increases the number of intermediate nodes by one to form a new number of intermediate nodes and the processor constructs a second shortest forest of paths between the set of destination nodes and a second set of source nodes, each path passing through the new number of intermediate nodes. The processor selects a second set of node-independent paths from the second shortest forest of paths, such that no two node-independent paths in the second set of node-independent paths pass through a same intermediate node. The processor uses the second set of node-independent paths to schedule movement of items from at least one of the source nodes in the second set of source nodes to at least one destination node in the set of destination nodes.

Each path has a limited capacity and scheduling movement of items from at least one source node in the set of source nodes to at least one destination node comprises setting occupancy values for paths between the source nodes and the destination nodes at time frames.

Each edge extends between two nodes, and each edge is defined by a transit time required for items to traverse the edge, wherein at least two edges have different transit times.

Selecting a second set of node-independent paths comprises identifying at least two paths that pass through a common intermediate node, determining total transit times along each path, and selecting the path with the lowest total transit time as a node-independent path and not selecting the other paths as node-independent paths.

A total transit time for a path comprises a delay time for each node along the path and an edge transit time for each edge along the path, the delay time for a node comprises a length of time that an item must spend at a node before it may begin moving along the edge leaving the node.

A computer-readable storage medium has instructions stored thereon that when executed by a processor cause the processor to perform steps comprising identifying conveyance schedules for a set of edges to move items from source nodes to destination nodes by utilizing dartboard network rings.

The source nodes comprise computing devices, the destination nodes comprise computing devices, and the conveyance paths comprise connections that link the source node computing devices to the destination node computing devices to allow data to move from the source node computing devices to the destination node computing devices in accordance with one embodiment.

Identifying conveyance schedules comprises identifying conveyance schedules for items on source nodes in an outer ring of the dartboard network rings before identifying conveyance schedules for items on source nodes in an inner ring of the dartboard network rings.

Identifying conveyance schedules comprises identifying a forest of paths comprising paths from each source node in a ring of the dartboard network rings to at least one destination node, selecting node-independent paths from the forest of paths, and scheduling conveyance of items along the node-independent paths.

Selecting node-independent paths from the forest of paths comprises identifying intersecting paths in the forest of paths that share at least one intermediate node, determining transit times along each intersecting path from a source node of the intersecting path to the destination node of the intersecting path, and selecting the intersecting path with the shortest transit time as a node-independent path.

Determining the transit time along an intersecting path comprises adding the transit time of each edge along the path to delay times for each node along the path, wherein a delay time for a node comprises an amount of time an item spends at the node before it can leave the node. At least two edges have different transit times from each other.

A conveyance planning system includes a processor receiving a set of source nodes that form at least part of a source zone, a distribution of items on the source nodes, a set of safe nodes that are outside of the source zone, and a set of edges, where each edge connects two respective nodes and conveys items between the two respective nodes. The processor forms conveyance schedules for edges in the set of edges to move the items from the source nodes to the safe nodes, each conveyance schedule indicates when items will be conveyed along the schedule's respective edge, wherein the conveyance schedules are formed iteratively such that during each iteration, items scheduled for conveyance all originate at source nodes that are in a same dartboard network ring within the source zone. A memory stores the conveyance schedules as a conveyance plan for the source zone.

The items comprise computer data that is to be stored outside the source zone and the nodes within the source zone comprise computing devices, the safe nodes comprise computing devices and the edges comprise communication paths, in accordance with one embodiment.

An iteration of forming conveyance schedules comprises identifying a forest of conveyance routes from source nodes within a same dartboard network ring to safe nodes, selecting node-independent conveyance routes from the forest of conveyance routes, and updating schedules for only those edges along the node-independent conveyance routes.

Selecting node-independent conveyance routes comprises identifying overlapping conveyance routes in the forest of conveyance routes wherein overlapping conveyance routes have at least one same intermediate node and selecting an overlapping conveyance route with a shortest conveyance time as a node-independent conveyance route.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an example of a network with a source zone and a destination zone.

FIG. 2 is a second example of a network with a source zone and destination nodes.

FIG. 3 is a method of scheduling the conveyance of items from a source zone to a destination zone.

FIG. 4 is an example of a shortest forest and node-independent paths formed during a first iteration of the method of FIG. 3.

FIG. 5 is a flow diagram of a method of scheduling the conveyance of items from a source node along node-independent paths.

FIG. 6 is a flow diagram of a method of identifying a shortest path from a source node in a source zone to a destination zone.

FIG. 7 is an example of a shortest forest and node-independent paths formed during a second iteration of the method of FIG. 3.

FIG. 8 is an example of a shortest forest and node-independent paths formed during a third iteration of the method of FIG. 3.

FIG. 9 shows initial node and edge occupancies before movement of items is scheduled.

FIG. 10 shows scheduled node and edge occupancies after a first iteration of scheduling.

FIG. 11 shows scheduled node and edge occupancies after a second iteration of scheduling.

FIG. 12 shows scheduled node and edge occupancies after a third iteration of scheduling.

FIG. 13 is a graph of the runtime performance of different methods of conveyance route planning as a function of the number of items conveyed.

FIG. 14 is a graph of the total conveyance time of different methods of conveyance route planning as a function of the number of items conveyed.

FIG. 15 is a graph of the runtime performance of different methods of conveyance route planning as a function of the number of source nodes.

FIG. 16 is a graph of the total conveyance time of different methods of conveyance route planning as a function of the number of destination nodes.

FIG. 17 is a graph of the runtime performance of different methods of conveyance route planning as a function of the number of items for a circular source zone.

FIG. 18 is a graph of the total conveyance time of different methods of conveyance route planning as a function of the number of items for an irregularly-shaped source zone.

FIG. 19 is a block diagram of an example of a computing device that may be used as either a server or a client device for performing the methods described herein.

### DETAILED DESCRIPTION

How to efficiently convey items across a network, such as a data network or a transportation network, is a technical problem that does not have simple solutions. One subset of the network conveyance problem is the movement of items out of a source zone to a destination zone. Examples of such movement include the evacuation of data and people from an area when a destructive or dangerous event is predicted for a region. Determining how to evacuate all of the data and/or people from the area in the most efficient manner is computationally complex and becomes increasingly more difficult to compute as the size of the network that the data or people will move across increases.

In the discussion below, networks are represented and analyzed as a graph composed of nodes and edges. Every node is defined in part by the capacity of the node, which represents the number of items that may be positioned at the node at any one time. Every edge represents a connection between two nodes and is defined by an edge capacity, which is the number of items that may be placed at the beginning of the edge at any one time, and a travel time, which is the number of time units required for items to traverse the edge. For the conveyance of data, the nodes are computing devices such as computers, servers, client devices, handheld devices and routers, for example, and the edges are communication paths between the computing devices such as electrical cable, optical cable, and wireless channels. For the conveyance of people and physical objects from a geographic area, the edges are transportation paths such as roads, sidewalks, rail lines and plane routes, and the nodes are geographic areas where two or more transportation paths intersect.

A sequence of nodes n1, n2, n3 . . . nn is called a path (or route) if there is an edge between each of the consecutive nodes in the sequence. (An edge between node n1 and node n2, an edge between node n2 and node n3, and so forth) A tree is an undirected graph in which any two nodes are connected by exactly one simple path. A forest is a disjoint union of trees. A set of paths from a source node s to a destination node d is a node-independent path if none of the paths share any nodes aside from s and d. These node-independent paths are not necessarily unique so that there may be more than one way of choosing a set of independent paths.

In accordance with some embodiments, items are moved from a source zone formed of multiple source nodes to a destination zone formed of multiple destination nodes using a set of dartboard network cuts (DBN-cut), which determine conveyance routes by constructing groups of nodes that form rings in the source zone. For example, source nodes that are connected to a destination node by a single edge form an outer ring, source nodes connected to the outer ring source nodes by a single edge form a next inner ring, and source nodes connected to those nodes form still a further inner ring and so forth. Conveyance paths or routes for people and data packets are determined for the outer ring source nodes first, then for the next ring of nodes and so forth until reaching the innermost ring of source nodes. To simplify the identification of conveyance paths for each source node, node-independent shortest routes are selected such that no two paths from a ring of source nodes share a node other than a source node in the ring or a destination node in the destination zone.

The problem of scheduling the movement of items, such as people and data packets, can be formalized as follows: Given a network with maximum node and edge capacity constraints, initial node occupancy, and destination locations, the objective is to find conveyance route scheduling that minimizes the conveyance time and minimizes the computational cost. The problem can be formally defined as:

Input:
a. a transportation network with non-negative integer capacity constraints on nodes and edges;
b. the total number of items and their initial locations; and
c. the location(s) of the destination(s).

Output:
a. a conveyance plan consisting of a set of origin-destination routes; and
b. a scheduling of items on each route.

Objective:
a. Minimize the computational cost of producing the conveyance plan; and
b. Minimize the total conveyance time.

Constraints:
a. Edge travel time preserves FIFO (First-In First-Out) property.
b. The scheduling of items on each route should observe the capacity constraints C; and
c. There is a limited amount of computer memory available to compute the conveyance plan.

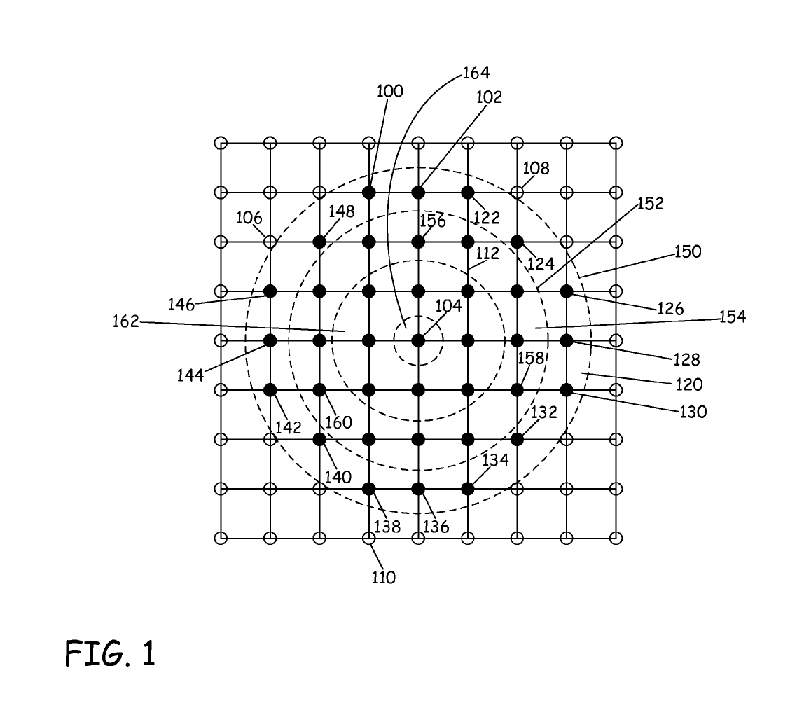

FIG. 1 provides a simplified network of nodes connected by edges. In FIG. 1, darkened circles such as circles 100, 102 and 104 represent source nodes positioned within a source zone and open circles such as circles 106, 108 and 110 represent destination nodes or safe nodes in a destination zone positioned outside of the source zone.

Conveying items from on one or more of the source nodes to destination nodes in the destination zone involves scheduling the movement of items along edges connected to the source nodes so that all of the items in the source zone reach the destination zone. To simplify scheduling, a sequence of fixed-length time frames can be established and used for all of the edges. Each fixed-length time frame represents a period of time such as 1 minute, 5 minutes, or 10 minutes, for example. During a time frame, items may be scheduled for movement along each edge. The number of items that can be placed on an edge during a time frame is limited to the capacity of the edge.

Instead of randomly selecting nodes and edges during conveyance scheduling, embodiments described herein use dartboard cuts to group source nodes into a dartboard network. In particular, the source nodes are grouped based on a number of edges or intermediate nodes that must be passed through to reach the destination zone following a shortest path from the source nodes to the destination zone. For example, an outer ring of nodes 120 consisting of nodes 100, 102, 122, 124, 126, 128, 130, 132, 134, 136, 138, 140, 142, 144, 146 and 148 is formed by identifying those nodes that are separated from a destination node by a single edge or by zero intermediate nodes. These nodes are positioned within two dartboard network cuts 150 and 152 wherein dartboard network cut 150 separates the destination nodes from the outer ring source nodes and dartboard network cut 152 separates the outer ring source nodes from an inner ring of source nodes 154, such as nodes 156, 158, and 160. The source nodes of inner ring 154 are each separated from the destination zone by at least two edges or alternatively, by one intermediate node. The dartboard network of FIG. 1 includes further rings 162 and 164, where nodes in ring 162 are at least three edges or two intermediate nodes from the destination zone, and nodes in ring 164 are at least four edges or three intermediate nodes from the destination zone.

Although the dartboard network and the dartboard network cuts are shown as being circular in FIG. 1, the cuts do not need to be circular and can be any required shape needed to group nodes based on the number of edges between the nodes and the destination zone.

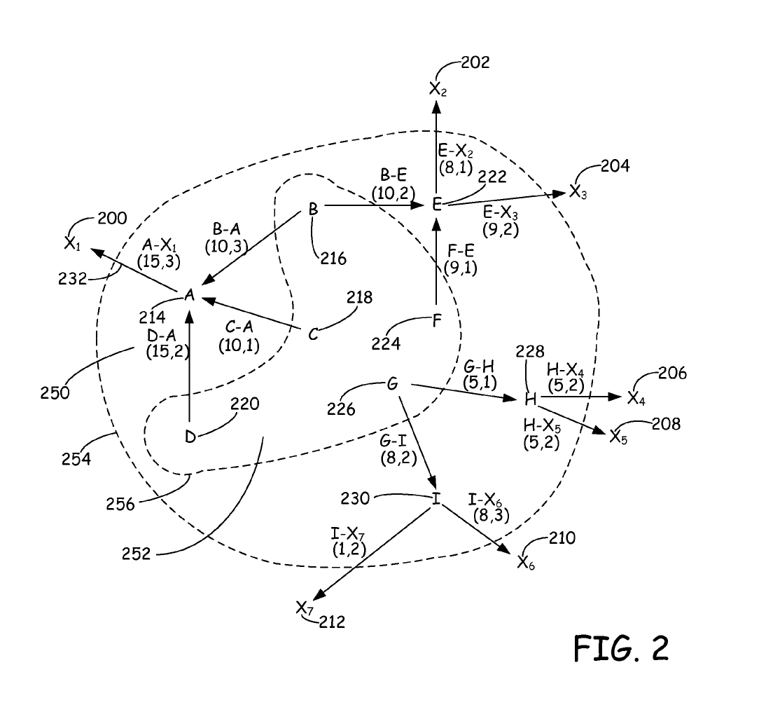

FIG. 2 provides an additional example of a source zone divided into a dartboard network. In FIG. 2, destination nodes (safe locations or safe nodes) that are located in a destination zone are referred to as x_{y} such as nodes 200, 202, 204, 206, 208, 210 and 212. Source nodes are labeled A-I such as nodes 214, 216, 218, 220, 222, 224, 226, 228 and 230. Edges are labeled based on the nodes they connect for instance edge 232 which connects node A to node X₁ is labeled A-X₁. In addition, the maximum capacity and transit time of each edge is shown in parenthesis below the label of the edge. For example, for edge 232, the maximum capacity and transit time are shown as (15, 3) where 15 is the capacity of the edge and 3 is the transit time of the edge.

As shown in FIG. 2, the source zone consists of nodes 214, 216, 218, 220, 222, 224, 226, 228 and 230 and has been divided into two dartboard rings 250 and 252 by two dartboard cuts 254 and 256.

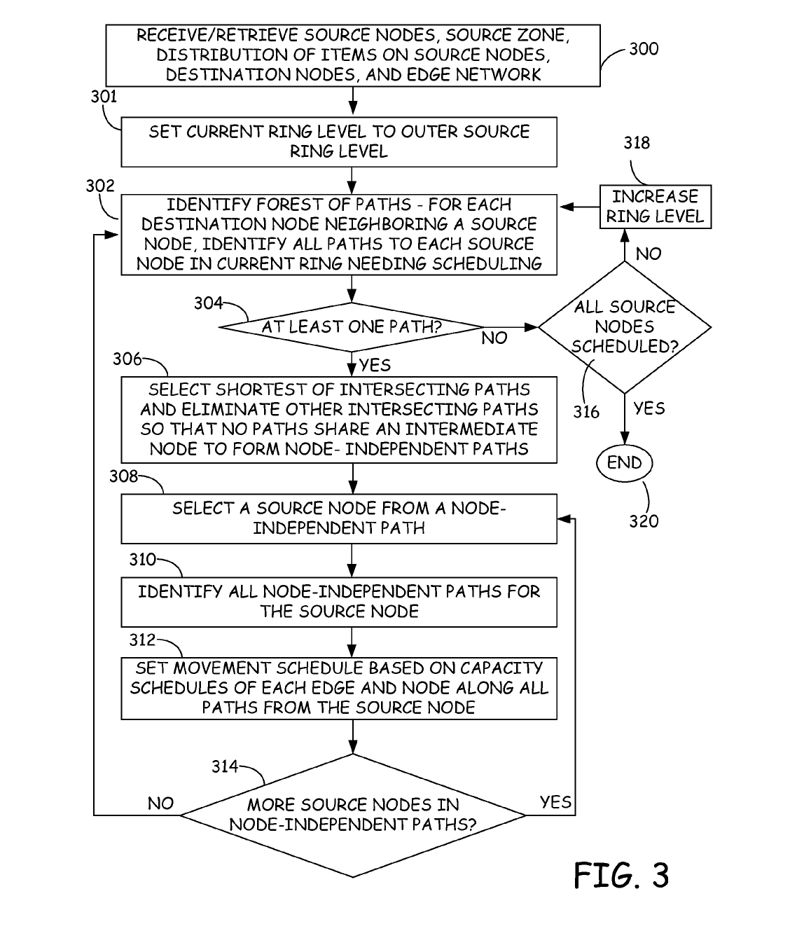

FIG. 3 provides a flow diagram of a method of scheduling the conveyance of items, such as data packets or people, from a source zone containing multiple source nodes to a destination zone. In FIG. 3, conveyance schedules are created for each edge in a network of edges used to convey items from source nodes to a destination zone. The conveyance schedules are formed iteratively, such that during each iteration, items scheduled for conveyance all originate at source nodes that are in a same dartboard network ring with a source zone. The conveyance schedules are stored together as a conveyance plan for the source zone and destination zone.

At step 300 of FIG. 3, a processor receives or retrieves a list of source nodes, a list of nodes in a source zone, a list of destination nodes, a distribution of items across the source nodes and a network of edges that connect nodes to each other. The distribution of items across the source nodes indicates how many items are present on each source node before conveyance begins. Such items are said to originate at those source nodes. The retrieved lists of source nodes, nodes in the source zone, and destination nodes also includes a capacity level for each node, which indicates the maximum number of items that may be present on the node at any one time. The network of edges includes a description of each edge in the network where each description includes the identities of the two nodes connected by the edge, the capacity of the edge and the traversal time of the edge. All of the information received or retrieved at step 300 may be retrieved or received from a computer-readable storage medium.

At step 301, a current ring level is set to an outer source ring level where the outer source ring level is the outermost ring of source nodes in the dartboard network. Explicitly partitioning the dartboard network into component rings is computationally inefficient. Instead, the embodiment of FIG. 3 sets the current ring level by setting the minimum number of edges or intermediate nodes that must be traversed along a path to reach a source node from the destination zone. For example, to set the ring level to the outermost ring, the number of edges that must be traversed from the destination zone to each source node is set to one or alternatively the number of intermediate nodes is set to zero. This implicitly results in the selection of the source nodes in the outermost ring.

At step 302, a forest of paths or routes is identified. This involves identifying all paths from the destination zone to a source node that have the requisite number of edges or intermediate nodes. For example, in the first iteration through step 302, all one-edge or zero-intermediate-node paths from the destination zone to a source node are determined. In accordance with one embodiment, if a source node does not have at least one item that needs to be conveyed, the paths to that source node are removed from the forest of paths.

In order to construct the shortest forest, a modified version of BFS is used. This algorithm works on the reverse graph, where each edge (u, v) in the original network is replaced by its reverse (v, u). Here, the search starts from the destination nodes and expands incrementally to include shortest routes to the source nodes. At termination, this process results in several shortest path trees, each rooted at a destination node. The individual trees in the forest are generated by traversing a parent pointer of all the leaf nodes. The edges in these trees are reversed (since Algorithm A works on reverse graph) to get the actual shortest trees

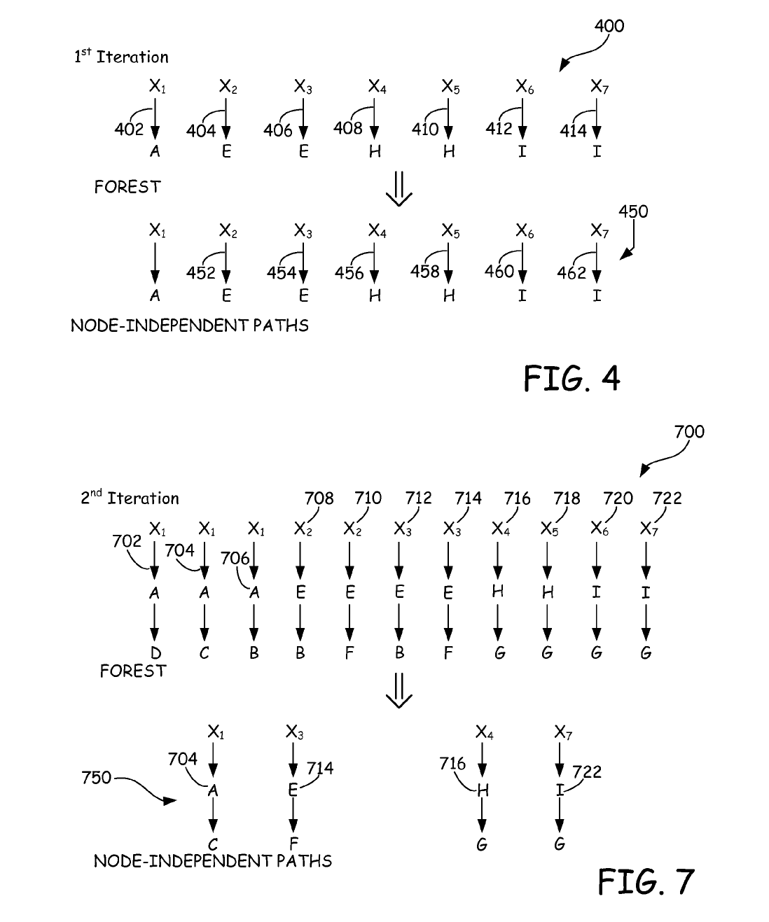

FIG. 4 shows a forest 400 formed at step 302 during a first iteration of the method of FIG. 3. Forest 400 is for the network shown in FIG. 2. As shown in FIG. 4, a single path 402 is shown in forest 400 for source node A; two paths 404 and 406 are shown for source node E; two paths 408 and 410 are shown for source node H and two paths 412 and 414 are shown for source node I.

At step 304, the method of FIG. 3 determines if there is at least one path in the forest of paths. If there is at least one path, the process of FIG. 3 continues in step 306 where node-independent paths, also referred to as node-independent routes or node-independent conveyance routes, are selected from the forest of paths. A node-independent path is a path that does not share an intermediate node with any other path, where an intermediate node is any node along the path that is not a source node or a destination node for that path. A path that does share at least one intermediate node with another path is referred to as an intersecting path or an overlapping conveyance route. Node-independent routes have been determined by the present inventors to be important to capacity constrained route planning because node-independent routes never share each other's capacity constraints at the same time during the route evaluation process.

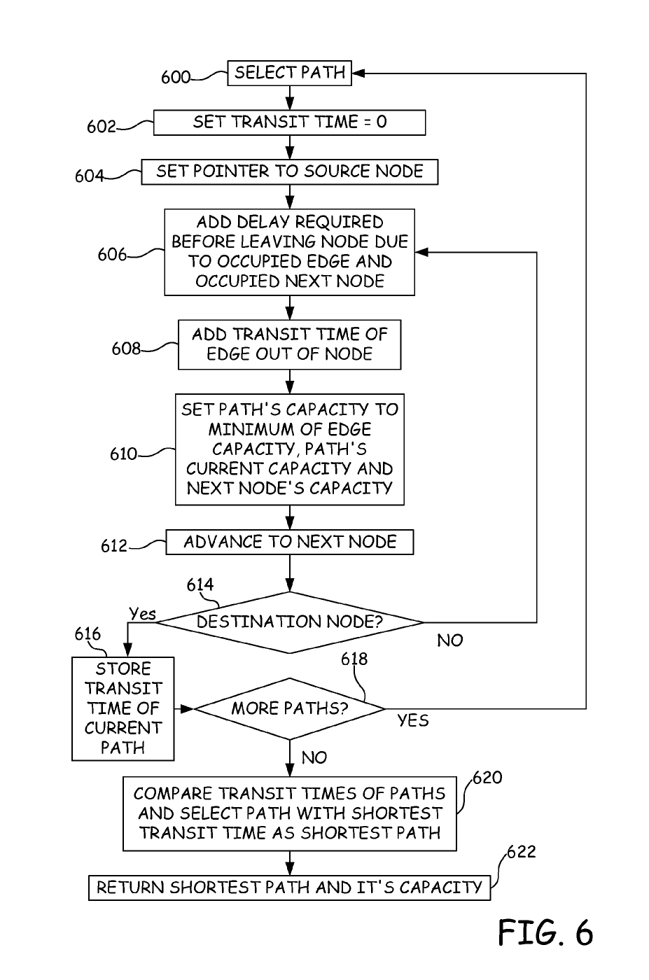

In step 306, if two paths share an intermediate node, and thus are intersecting paths, the shortest of the intersecting paths is selected and the other intersecting paths are removed from the forest of paths. FIG. 6, described further below, provides one technique for identifying which of the intersecting paths is shortest. If two or more paths are the same length, the path with the greater path capacity is select in accordance with some embodiments.

In step 306, a path is considered to be shortest if the transit time or conveyance time required to move one item along the entire length of the path is shorter than the time required to move an item along the entire length of any of the other intersecting paths. Thus, the path that will evacuate an item from the source zone the quickest is selected in step 306. Note that the conveyance time is different from the number of edges between the source node and the destination zone. In step 306, all of the paths should have the same number of edges and intermediate nodes between the source node and the destination zone. However, the paths can have different transit times.

FIG. 4 shows an example of node-independent paths 450 produced in step 306 during the first iteration through the method of FIG. 3 for the network of FIG. 2. Since there are no paths that intersect an intermediate node in forest 400, all of the paths present in forest 400 are also present as node-independent paths 450. Note that this is true even though some of the paths share the same source node.

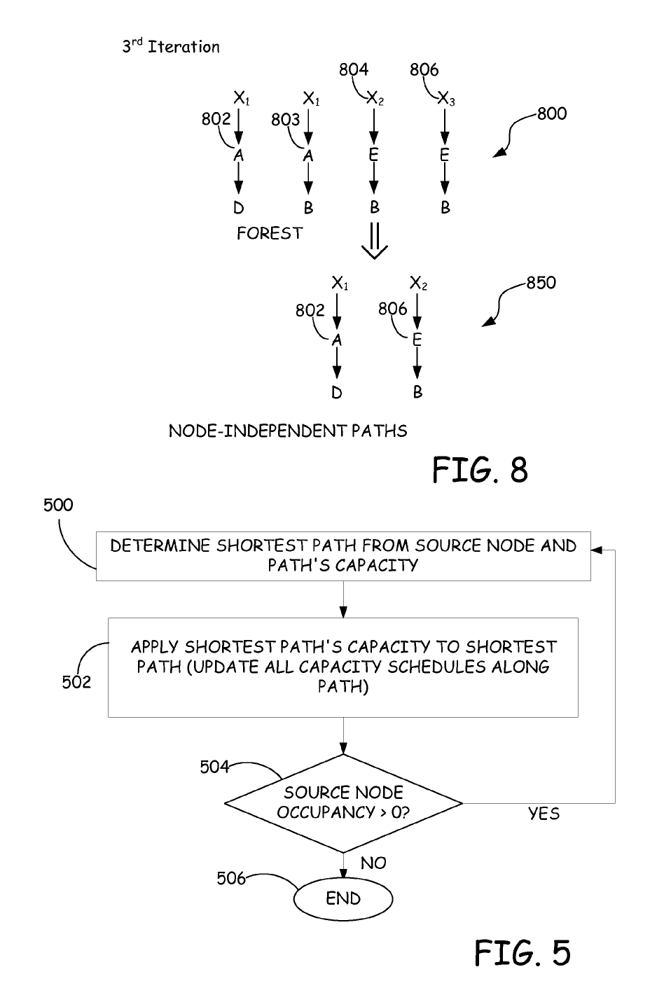

At step 308, a source node is selected from a node-independent path and at step 310, all of the node-independent paths for the selected source node are identified. For example, if source node E of FIG. 4 were selected, the node-independent paths of X₂-E and X₃-E would be identified at step 310. At step 312, a movement schedule for moving items from the selected source node to one or more destination nodes is set based on capacity schedules of each edge and node along all the paths from the source node. FIG. 5 provides a flow diagram of a method of setting the movement schedules for items on a source node.

In step 500 of FIG. 5, the shortest path from the source node and the path's capacity is determined. FIG. 6 provides a flow diagram of a method of determining the shortest path from a source node and that path's capacity.

In step 600 of FIG. 6, a processor selects a path from the node-independent paths that extend from the source node. At step 602, the transit time along the path is set to zero and at step 604 a pointer is set to the source node. At step 606, the delay before leaving the node due to an occupied edge or occupied next node is added to the transit time. For example, if the capacity of the edge is already filled for the first time frame, a delay of one time unit is added to the transit time because an item cannot be placed on the edge during the first time interval but must wait until the second time interval. Similarly, if the next node is already fully occupied at the time the item would arrive after traversing the edge, the delay required before the next node can accept an item is added to the overall transit time.

At step 608, the transit time or traverse time of the edge leaving the node is added to the overall transit time. The transit time of an edge is the amount of time required for an item to traverse the edge from the current node to the next node.

At step 610, the current path's capacity is set to the minimum of the edge's available capacity, the path's current capacity, and the next node's available capacity. Initially, the path's current capacity is set to the occupancy of the source node. Thus, if the path's current capacity was twenty items, the edge capacity was three items, and the next node's capacity was fifteen items, the path's capacity would be set to three to match the edge capacity, which is the minimum of the three capacities.

At step 612, the processor advances to the next node along the selected path. If the next node is not a destination node, the processor returns to step 606 to add delay required before leaving this new node due to an occupied edge or due to the next node being occupied. Steps 606, 608 and 610 are then repeated for the new node. Thus, with each node along the path, a delay time required to leave the node and the time required to traverse the edge that leaves the node are added to the path's transit time. Further, the path's capacity continues to be adjusted so that it matches the minimum available capacity of any edge or node along the path.

When a destination node is reached at step 614, in other words when the item is outside of the source zone and is within the destination zone, the full path has been traversed and the transit time for the path has been determined. The processor then stores the transit time at step 616. At step 618, the processor determines if there are more paths in the set of node-independent paths leaving the source node. If there are more paths, a new path is selected at step 600 and steps 602, 604, 606, 608, 610, 612, 614, and 616 are repeated.

When there are no more node-independent paths leaving the source node at step 618, the transit times for all the paths are retrieved from memory by the processor and are compared to each other such that the path with the shortest transit time is selected as the shortest path at step 620. The shortest path and its capacity are then returned at step 622. Note that the returned shortest path will have a minimum capacity of at least one item.

Returning to FIG. 5, after determining the shortest path from the source node and the shortest path's capacity at step 500, the processor updates all capacity schedules along the path at step 502. In particular, the capacity schedules for each edge and node along the path are updated with the path's capacity. Updating a capacity schedule for an edge or a node involves increasing the occupancy of the edge or node by the amount of the shortest path's capacity during the time units that the items will be present on the node or will begin to traverse the node. Examples of updating capacity schedules along a path are described further below.

At step 504, the processor determines if the source node's occupancy is greater than zero. If it is greater than zero, the processor returns to step 500 to determine the shortest path from the source node and the shortest path's capacity. Thus, the method of FIG. 6 is repeated for the source node. Note that each time step 500 is performed, a different shortest path may be selected. The reason for this is that after a path is selected as the shortest path, the path's available capacity is filled during step 502. This means that at least one edge or node along the path is filled for at least one time frame.

When the source node's occupancy is equal to zero at step 504, the process of FIG. 5 ends at step 506. This marks the end of step 312 of FIG. 3, where the movement schedule has been set based on the capacity schedules of each edge and node along all paths from the source node.

Returning to FIG. 3, at step 314, the processor determines if there are more source nodes in the set of node-independent paths. If there are more source nodes, the processor returns to step 308 and selects a new source node from the node-independent paths. Then steps 310 and 312 are repeated for the new source node. When there are no more source nodes in the node-independent paths at step 314, the processor returns to step 302 to identify a forest of paths for each source node in the current ring needing scheduling. Note that a new forest of paths must be determined at step 302 because some of the paths in the previous forest of paths are eliminated at step 306. Thus, some source nodes may not be processed in steps 308, 310 and 312 for the current ring. If at least one path is identified at step 304, steps 306, 308, 310, 312 and 314 are repeated for the new forest of paths.

If at least one path cannot be identified for the current ring level at step 304, the processor continues at step 316 where it determines if all of the items on each of the source nodes in the source zone have been scheduled for movement out of the source zone.

If all of the source nodes have not been scheduled at step 316, the processor increases the ring level at step 318, which is equivalent to moving to a more inner ring from the current ring of the dartboard network. Thus, increasing the ring level at step 318 involves moving to nodes that are one edge or one intermediate node further from the destination zone. After increasing the ring level at step 318, the processor returns to step 302 and identifies a forest of paths for the source nodes in the new ring. Steps 302, 304, 306, 308, 310, 312, and 314 are then repeated for the nodes of the new ring level. Thus, in accordance with various embodiments, items such as people and data packets are scheduled for movement in an outside-in approach such that items on nodes closets to a destination zone are scheduled first and items further from the destination zone are scheduled for movement later.

When all of the source nodes have been scheduled at step 316, the process of FIG. 3 ends at step 320. When the processor reaches step 320, the schedules for each of the edges and nodes have been stored in memory and can later be used to coordinate the movement of items from the source zone to the destination nodes outside of the source zone.

The methods of FIGS. 3, 5 and 6 can be described in relation to an example shown in FIGS. 2, 4 and 7-12.

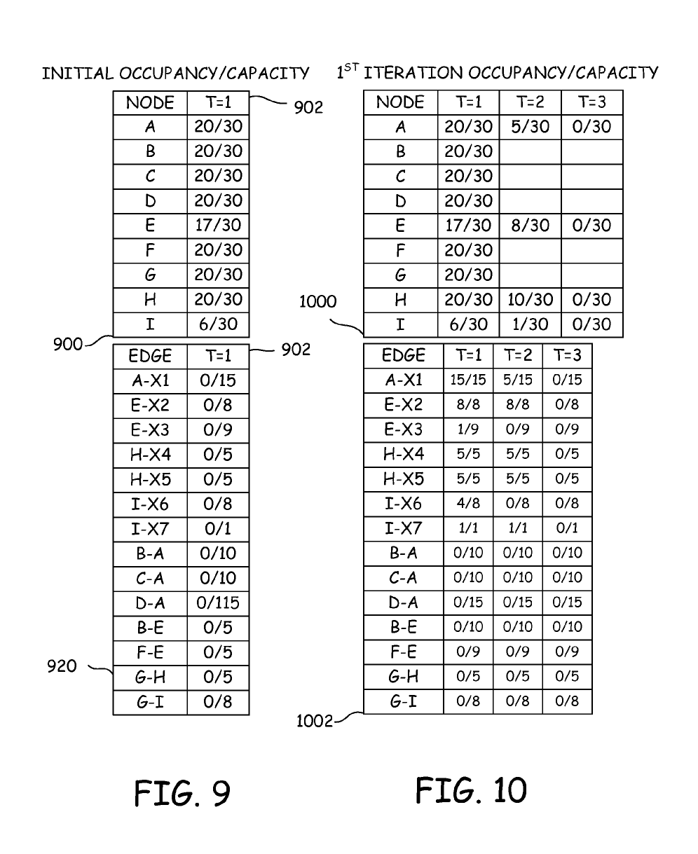

FIG. 9 provides an example of an initial movement schedule showing the occupancy and capacity of each node and edge in FIG. 2. In particular, table 900 provides the occupancy/capacity of each of the nodes at an initial time frame 902 and table 920 provides occupancy/capacity values for each edge in the network of FIG. 2 at time frame 902. As shown in FIG. 9, initially, each edge has zero occupancy at time frame T=1 while nodes A-I each have at least one item that needs to be moved from the source zone. In other embodiments, one or more of the source zone nodes may be empty initially.

As discussed above, during the first iteration through FIG. 3, the forest of paths 400 and the node-independent paths 450 of FIG. 4 are produced during steps 302 and 306, respectively. During the first iteration of step 312 of FIG. 3, the node-independent paths 450 are used to produce a second version of the movement schedule as shown in tables 1000 and 1002 of FIG. 10. Table 1000 contains updated occupancy values for the nodes of FIG. 2 and table 1002 provides updated occupancy values for the edges of FIG. 2 at various time frames designated as T=1, T=2, T=3, T=4, T=5, T=6, and T=7.

During the first iteration through FIG. 3, node A is initially selected at step 308 and node independent path A-X₁ is identified at step 310. At step 312, the method of FIG. 5 is triggered. During the initial pass through the flow diagram of FIG. 5, A-X₁ is identified as the shortest path with a capacity of 15. As a result, at time frame T=1, fifteen items are placed on edge A-X₁ and the number of items on node A is reduced by fifteen so that it has a value of five at time frame T=2. On the second iteration through the method of FIG. 5, the shortest path is once again edge A-X₁ and the five remaining items one node A are applied to edge A-X₁ at time frame T=2. Thus, the occupancy of edge A-X₁ at time frame T=2 is set to five and the number of items at node A is reduced from five to zero at time frame T=3.

Returning to step 308, node E is selected and paths 452 and 454 of FIG. 4 are identified at step 310. The movement schedule is then updated for the items on node E at step 312 using the method of FIG. 5. Specifically, during a first iteration through the method of FIG. 5, path 452 is identified as the shortest path since it has a transit time of one compared to a transit time of two along path 454. The capacity of the path 452 is eight and so eight items are scheduled for movement along edge E-X₂ at time frame T=1 and the number of items on node E is reduced by eight to nine at time frame T=2. During the next iteration through FIG. 5, paths 452 and 454 are found to have the same transit time of two. Path 452's transit time is based on a delay of one time unit before items can be placed on edge E-X₂ and a transit time of one time unit along edge E-X₂. Path 454's transit time is based on a transit time of two time units along edge E-X₃. Since the same transit time is provided by each path, path 452 is selected again. Thus, eight items are scheduled for movement along edge E-X₂ at time frame T=2 and the number of items on node E at time frame T=3 is set to one. During the third iteration of the method of FIG. 5, the total transit time for path 452 increases to three time units: two time units due to edge E-X₂ being fully occupied during the first two time frames and one time unit due to the transit time of edge E-X₂. However, path 454 has a total transit time of two due to the transit time of edge E-X₃. As a result, the processor selects path 454 during the third iteration through the method of FIG. 5 and schedules the movement of the last remaining item on node E to begin traversing edge E-X₃ at time T=1. As a result of the scheduling, the number of items on node E at time frame T=2 and T=3 is reduced by one resulting in zero items being present on node E at time frame T=3. At this point, node E has an occupancy of zero and the method of FIG. 5 ends for node E.

Returning to step 308, node H is selected and paths 456 and 458 are identified at step 310. Returning to FIG. 5, the processor initially identifies path 456 as the shortest path since paths 456 and 458 have the same transit time and either of the paths may be arbitrally selected. The minimum capacity of path 456 is the capacity of edge H-X₄, which is five. As a result, five items are scheduled for movement along edge H-X₄ at time frame T=1 and the number of items on node H is set to fifteen at time frame T=2. During the next iteration through FIG. 5, path 458 is the shorter path because path 456 now has a delay of one time unit due to its full occupancy during time frame T=1. Thus the transit time along path 456 would be three time units and the transit time along path 458 would be two time units. As a result, path 458 is selected during this iteration and the maximum capacity of five items is applied to edge H-X₅ at time frame T=1. The number of items on node H at time frame T=2 is also reduced by an additional five items to ten items.

During the next iteration through the method of FIG. 5, path 456 is once again identified as the shortest path since it has a total transit time of three and path 458 also has a total transit time of three due to the delay in initiating items along edges H-X₄ and H-X₅. As a result, path 456 is arbitrarily selected and five items from node H are applied to edge H-X₄ at time T=2. The number of items on node H is then reduced to five at time frame T=3. During the next iteration through the method of FIG. 5, path 458 is identified as being shorter than path 456 due to the delay of two time units along edge H-X₄ compared to the delay of one time unit along edge H-X₅. As a result, path 458 is selected and the remaining five items from node H are applied to edge H-X₅ at time frame T=2. The number of items on node H is then reduced to zero at time frame T=3.

Returning to FIG. 3, node I is then selected at step 308 and node-independent paths 460 and 462 are selected at step 310. Using the same techniques described above, the processor iterates through the method of FIG. 5. During the first iteration through the method of FIG. 5, the processor assigns one item from node I to edge I-X₇ at time frame T=1 and reduces the number of items on node I at time frames T=2 by one. During the second iteration, the processor assigns one item from node Ito edge I-X₇ at time frame T=2 and reduces the number of items on node I at time frame T=3 by one. During the third iteration, the processor assigns four items from node Ito edge I-X₆ at time frame T=1 and reduces the number of items on node I at time frames T=2 and T=3 by four, resulting in zero items being present on node I at time frame T=3. The selection of edge I-X₆ during the third iteration is due to the transition time along path 462 increasing to four time units due to the delay of two time units to initiate movement of items along edge I-X₇ and the two-time-unit traversal time for edge I-X₇ as compared to the three time unit traversal time along edge I-X₆. As a result of the scheduling of movement of items along edges I-X₆ and I-X₇, the occupancy at node I is reduced from 6 to 1 at time T=2 and from 1 to 0 at time T=3.

This marks the end of the first iteration of steps 302-314 of FIG. 3. As can be seen from FIG. 10, all of the items in the first ring 250 of FIG. 2 have been scheduled for movement such that nodes A, E, H and I have been emptied of all the items that were originally on those nodes before the conveyance began.

After the items on nodes A, E, H and I have been scheduled for movement, the ring level is increased at step 318 of FIG. 3. This involves increasing the number of edges or intermediate nodes required for paths in step 302 by one. In particular, each path in the forest of paths determined in step 302 must now have two edges or one intermediate node connecting the destination zone to a source node instead of one edge or zero intermediate nodes.

At step 302, a forest of paths is identified based on the new path length producing forest 700 of FIG. 7 for ring 252 of FIG. 2. At step 306, node-independent paths 750 are selected from forest 700 by selecting the shortest of intersecting paths and eliminating other intersecting paths so that no paths share an intermediate node. For example, paths 702, 704 and 706 of FIG. 7 all intersect at node A. Thus, one of these paths is to be selected and the other two are to be eliminated from consideration during this iteration. To select the shortest path, the method of FIG. 6 is employed using the current state of the movement schedule shown in FIG. 10. Using the method of FIG. 6, the processor determines that path 704 is the shortest path. Similarly, for paths 708, 710, 712 and 714, which each intersect at node E of FIG. 2, the processor determines that path 714 is the shortest path for removing an item from one of nodes F and B to the destination zone. Note that paths 710 and 714 have equivalent lengths and the selection of path 714 over path 710 is arbitrary. The processor also selects path 716 out of paths 716 and 718, which intersect at node H. Paths 716 and 718 have identical transit times and as such the selection of path 716 is arbitrary. The processor also selects path 722 for intersecting paths 720 and 722 because path 722 has the shorter transit time.

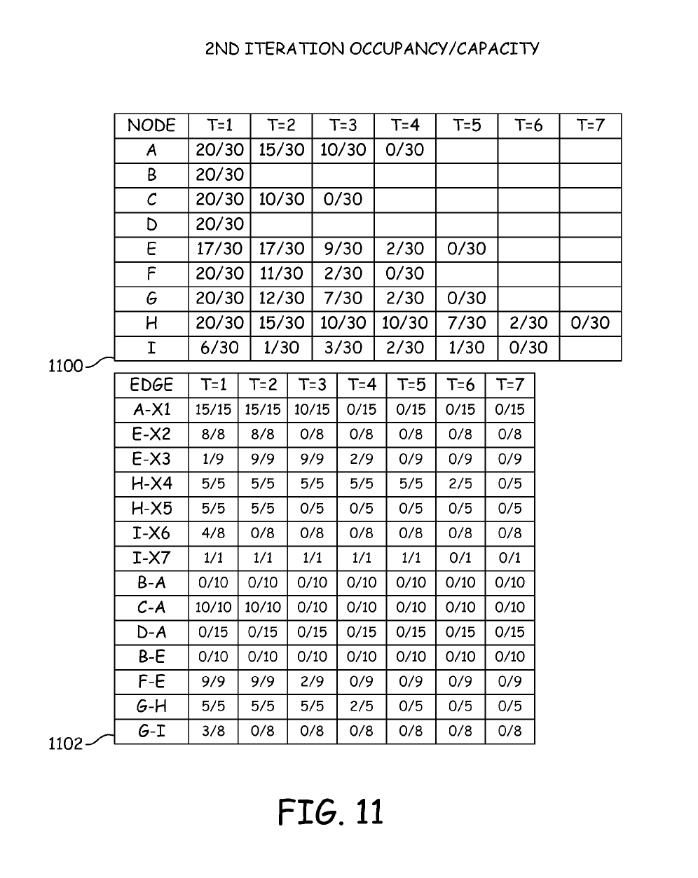

Steps 308, 310, 312 and 314 are then performed for the source nodes in node-independent paths 750 of FIG. 7 to produce an updated movement schedule shown in tables 1100 and 1102 of FIG. 11.

During the first pass through steps 308, 310, 312 and 314, node-independent path 704 is selected. As above, updating the movement schedule at step 312 involves multiple iterations through the method of FIG. 5.

During the first iteration through FIG. 5, the movement schedule is updated to indicate movement of ten items along edge C-A at time frame T=1, to indicate that the number of items at node C is reduced by ten at time frame T=2, and to indicate that the number of items on node A is increased by ten at time frame T=2. The additional ten items on node A are then scheduled for movement along edge A-X₁ at time frame T=2, resulting in zero items being on node A at time frame T=3 and edge A-X₁ being at full occupancy (fifteen) at time frame T=2.

During the next iteration through FIG. 5, ten additional items from node C are placed on edge C-A at time frame T=2, the number of items on node C is reduced to zero at time frame T=3, and the number of items on node A is increased by ten at time frame T=3. Ten items are then placed on edge A-X₁ at time frame T=3. Since node C is now empty, path 750 is done being processed.

Returning to step 308 of FIG. 3, node F is selected and at step 310, path 714 is selected. Step 312 is then performed for path 714 using the method of FIG. 5. During the initial iteration through FIG. 5, nine items are moved from node F at time frame T=1 along edge F-E. The number of items at node F is reduced by nine at time frame T=2 and the number of items at node E is increased by nine to seventeen at time frame T=2. The nine additional items on node E are then placed on edge E-X₃ at time frame T=2. During the second iteration through FIG. 5, nine items are placed on edge F-E at time frame T=2 resulting in an increase in the number of items on node E at time T=3 to nine and a reduction in the number of items on node F at time frame T=3 to two. The nine additional items on node E are placed on edge E-X₃ at time frame T=3. During the third iteration through FIG. 5, the two remaining items on node F are placed on edge F-E at time frame T=3, reducing the number of items on node F to zero at time frame T=4 and increasing the number of items at node E to two at time frame T=4. The two items on node E are placed on edge E-X₃ at time frame T=4 such that there are no items on node E at time frame T=5.

Returning to step 308 of FIG. 3, node G is selected and at step 310 two paths 716 and 722 are identified as possible node-independent paths. Step 312 is then performed using the method of FIG. 5 and both path 716 and path 722.

During the first path through the method of FIG. 5, the processor determines that paths 716 and 722 have the same transit time and arbitrarily selects path 716. Note that in other embodiments, path 716 is selected because it has a higher capacity than path 722. After selecting path 716, the processor updates the movement schedule by scheduling the movement of five items along edge G-H at time frame T=1 and reducing the number of items on node G by five at time frame T=2. The processor also increases the number of items on node H by five at time frame T=2. The processor then schedules movement of the five additional items along edge H-X₄ at time frame T=3. Since this represents a delay of one time unit, the processor also increases the number of items on node H by five for time frame T=3 since the five additional items must wait on node H until time frame T=3.

During the second iteration through the flow diagram of FIG. 5, path 722 is identified as the shortest path by the processor. As such, the processor schedules one item to be moved along edge G-I at time frame T=1 and reduces the number of items on node G by one at time frame T=2. The processor then sets the number of items on node I at time frame T=3 to one. The processor then schedules the movement of the one additional item along edge I-X₇ at time frame T=3 and sets the number of items on node I at time frame T=4 to zero.

During the third iteration of FIG. 5, the processor once again selects path 716 as the shortest path and schedules the movement of five items from node G along edge G-H at time frame T=2. It then sets the number of items on node G at time T=3 to nine items, which is five less than the number of items at time frame T=2. The processor also increases the number of items on node H by five at time frame T=3, resulting in ten items being on node H at time frame T=3. The processor then schedules movement of the five additional items along edge H-X₄. Since this edge is fully occupied at time frame T=3, the five items are held on node H until time frame T=4, when they are placed on edge H-X₄. Thus, five items are placed on node H at time frame T=4.

In the fourth iteration of the flow diagram of FIG. 5, path 722 is identified as the shortest path for node G and one item is scheduled to be moved along edge G-I at time frame T=1. The number of items on node G is reduced by one for time frames T=2 and T=3 such that the number of items on node G at time frame T=2 is thirteen and the number of items on node G at time frame T=3 is eight. The number of items on node I is also increased by one for time frame T=3 to a value of two. Since edge I-X₇ is fully occupied at time frame T=3, the additional item is held on node I until time frame T=4, when it is placed on edge I-X₇. Thus, the number of items on node I at time frame T=4 is set to one.

During the fifth iteration through the method of FIG. 5 for node G, path 716 is selected once again as the shortest path and five items are scheduled to be moved along edge G-H at time frame T=3. The number of items on node G at time frame T=4 is set to three, which is five less than the number of items on node G at time frame T=3. The number of items on node H is increased by five for time frame T=4. Since edge H-X₄ is fully occupied at time frame T=4, the five additional items are held on node H until time frame T=5, when they are placed on edge H-X₄. Thus, the number of items on node H at time frame T=5 is set to five.

During the sixth iteration of the flow diagram of FIG. 5, path 722 is again identified as the shortest path and the processor schedules movement of one item along edge G-I at time frame T=1. The number of items on node G is decreased by one for time frames T=2, T=3 and T=4 so that the number of items at time frame T=2 is twelve, the number of items at time frame T=3 is seven and the number of items at T=4 is two. The number of items on node I is increased by one for time frame T=3. Since edge I-X₇ is fully occupied at time frames T=3 and T=4, the additional item is held on node I during time frames T=4 and T=5 and then is placed on edge I-X₇ at time frame T=5. Thus, the number of items on node I at time frame T=4 is set to two and the number of items on node I at time frame T=5 is set to one.

During the seventh and final iteration of the flow diagram of FIG. 5 for node G, path 716 is selected as the shortest path. As such, the two remaining items on node G are placed on edge G-H at time frame T=4 and the number of items on node G at time frame T=5 is set to zero. The processor then increases the number of items on node H for time frame T=5 by two so that seven items are on node H at time frame T=5. Since edge H-X₄ is fully occupied at time frame T=5, the two additional items are held on node H until time frame T=6, when they are placed on edge H-X₄.

After the movement has been scheduled for each of the node-independent paths at step 314 of FIG. 3, the movement schedule is in the state shown in FIG. 11. The method of FIG. 3 then returns to step 302 to generate a new forest of paths.

FIG. 8 provides an example of a forest of paths 800 that is generated upon returning to step 302. Forest 800 includes paths 802 and 803 for source node D of ring 252 and paths 804 and 806 for source node B of ring 252. These source nodes were not processed previously because the paths for these source nodes were eliminated during step 306 for intersecting a shorter path from the source nodes to the destination zone.

After forest 800 is identified at step 302, the shortest node-independent paths 850 are selected at step 306. Paths 802 and 803 intersect at node A. Since path 802 is the shorter of the two paths, it is selected as one of the node-independent paths 850. Paths 804 and 806 intersect at node E. Since path 806 is the shorter of the two paths, it is selected as the other of the node-independent paths 850.

Steps 308, 310, 312 and 314 are then iterated for node-independent paths 850. FIG. 12 provides an example of an updated occupancy schedule 1200 for each node and an updated movement schedule 1202 for each edge based on the iteration of these steps.

During the first iteration of steps 308 and 310 for node-independent paths 850, node D and path 802 are selected and at step 312, the process of FIG. 5 is used to schedule movement of items from node D. During the first iteration of FIG. 5, fifteen items are placed on edge D-A at time frame T=1 and the number of items on node D is reduced to five at time frame T=2 while the number of items on node A is increased by fifteen at time frame T=3. Because edge A-X₁ is partially occupied at time frame T=3, only five items can be placed on edge A-X₁ at time frame T=3. The remaining ten items must be held on node A until time frame T=4, when they are placed on edge A-X₁. During the next iteration of the flow diagram of FIG. 5, the processor schedules the movement of the five remaining items on node D along edge D-A at time frame T=2 and reduces the number of items on node D to zero at time frame T=3. The processor also increases the number of items on node A by five at time frame T=4. The processor then schedules movement of the five additional items on edge A-X₁ at time frame T=4 and sets the number of items on node A to zero at time frame T=5.

Steps 308, 310 and 312 are then repeated, causing the method of FIG. 5 to be iterated for node B using path 806. During the first iteration of the method of FIG. 5, the processor initially schedules movement of ten items along edge B-E at time frame T=1 and reduces the number of items on node B to ten at time frame T=2. The processor increases the number of items on node E at time frame T=3 by ten to nineteen items. The processor then schedules movement of eight items along edge E-X₂ at time T=3. Since two of the items from node B cannot be moved along edge E-X₂ at time T=3, those two items are held at node E until time T=4, when they are placed on edge E-X₂. Since two items are held on node E until time T=4, the number of items on node E at time frame T=4 is increased to four.

During the next iteration of the method of FIG. 5, the processor schedules the movement of ten items along edge B-E at time T=2. The processor also decreases the number of items on node B at time T=3 to zero. The number of items on node E is increased by ten at time frame T=4 to fourteen items. Because edge E-X₂ is partially filled at time frame T=4, only six of the ten items may be placed on edge E-X₂ at time T=4. The remaining four items are held on node E until time frame T=5, when they are placed on edge E-X₂.

At this point, none of the nodes have any items left on them and all of the items have been conveyed to the destination zone.

The embodiments described above provide a technique for scheduling the movement of items from a source zone by grouping multiple node-independent shortest routes to reduce the number of search iterations. For example, instead of a single-route shortest-path algorithm, the techniques above use node-independent shortest-paths to aggregate items on different nodes and evaluate conveyance routes without sacrificing the quality of the conveyance route plan. In particular, Dartboard Network cuts group multiple node-independent shortest routes and reduce iterations when scheduling the movement of items.

Although two networks have been described above, the embodiments herein may be used with other networks. The movement of items in these different networks will be different than described above, but the technique for scheduling the movement of the items would be the same.

In accordance with one embodiment, the techniques described above were applied to a network consisting of 8,868 nodes and 24,126 edges. In accordance with this embodiment, the processor executed instructions written for Java 1.7 in a 1 GB memory run-time environment. The processor was an Intel Core i7-2670QM running MS Windows 7 with 8 GB of RAM. Two source zones were defined: one for a circular area and the other for a riverside area. The circular area was defined as having a radius R and the riverside area was defined as a buffer area with width R measured from a river.

Two embodiments were tested against an existing Capacity Constrained Route Planner (CCRP). The first embodiment is referred to as Dartboard Network Cuts-Conveyance Route Planner with node-independent shortest paths(DBNC-CRP with NI). This is the embodiment in which the shortest path forest is pruned to remove paths so that the remaining paths are node-independent. The second embodiment is referred to as Dartboard Network Cuts-Conveyance Route Planner with shortest Forest (DBNC-CRP with forest). This second embodiment is the same as the embodiments described above except instead of pruning paths that are not node-independent before scheduling item movement, the intersecting paths are removed as part of scheduling the item movement due to occupied edges. The property of node-independent routes is easily exploited to reduce the computational time by reducing each iteration. However, the DBNC-CRP algorithm with node-independent shortest paths uses two route scans to evaluate the availability: one scan for node dependency and the other for capacity constraints. Intuitively, the shortest forest embodiment uses partially node-independent routes. The strength of this approach is that it reduces route checking time when the number of available routes is large. The main disadvantage is that it may yield false positive node-independent routes that will be removed when setting the movement of items.

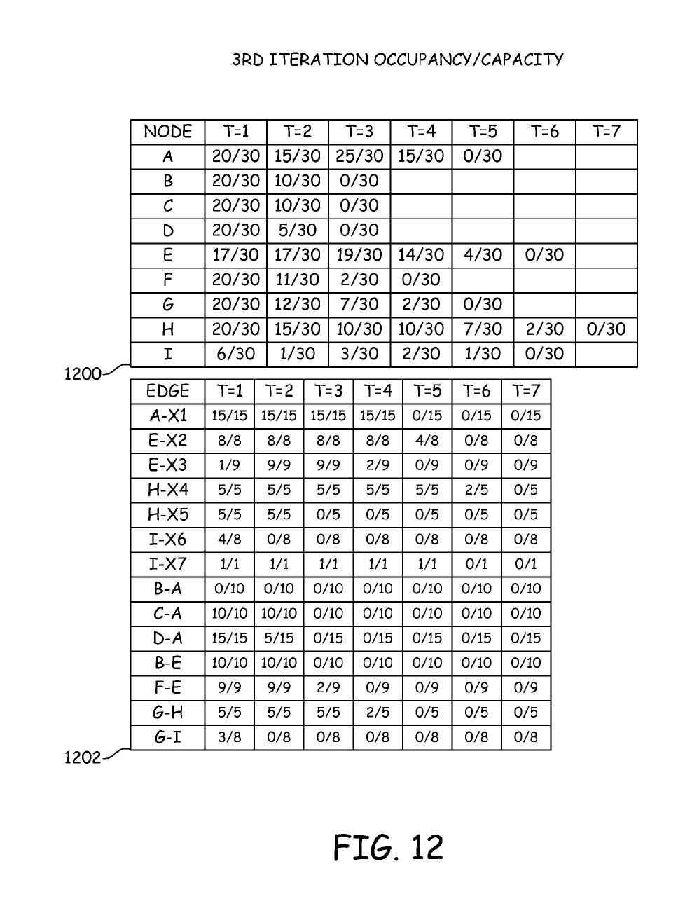

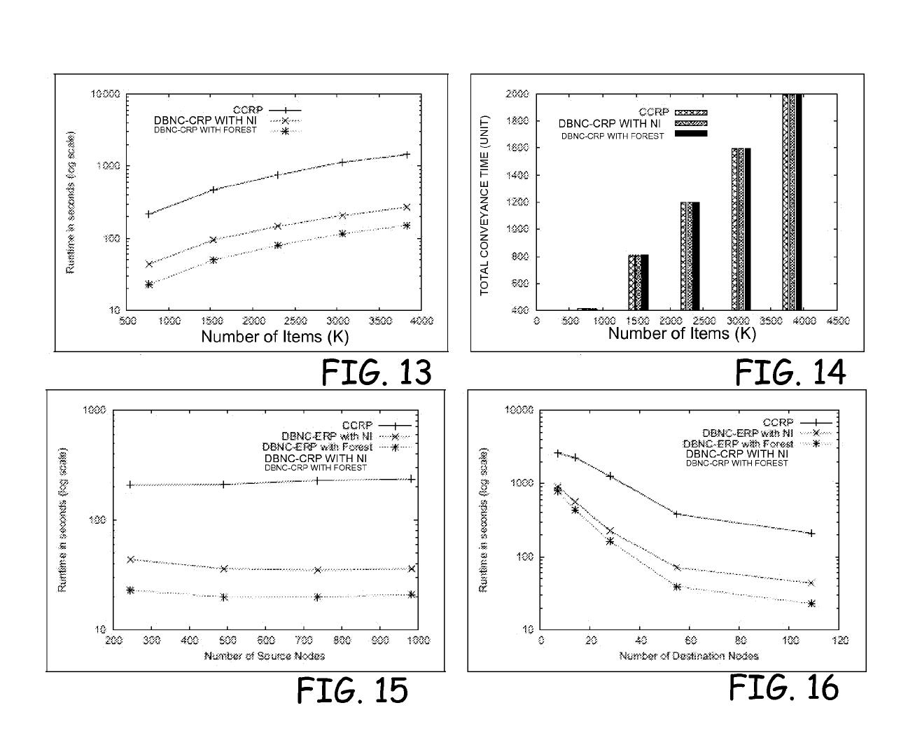

The purpose of a first experiment was to evaluate the effect of the number of items on the performance of the techniques. The number of source and destination nodes was fixed. The experiment was done using networks of 246 source nodes, 109 destination nodes, and 1,847 nodes for a circular source zone. The number of items was incrementally increased from 766,123 to 3,064,492. FIG. 13 shows that the two DBNC-CRP approaches outperform CCRP. As the number of items increased, the performance gap also increased. This is because the DBNC-CRP approaches group the node-independent routes to minimize the iterations. DBNC-CRP with a forest shows slightly better performance compared to DBNC-CRP with IN due to the large size of node-dependency checking time. FIG. 14 shows the solution quality represented by total conveyance time. The three approaches produce the same solution for total conveyance time. As the number of items grows, the total conveyance time increases.

A second experiment evaluated the effect of the number of source nodes on the performance of the techniques. The number of destination nodes and the number of items was fixed. To increase the number of source nodes, source nodes share the items with new source nodes. The experiment was done using networks of 109 destination nodes, 1,847 nodes for a circular source zone, and 766,123 items. The number of source nodes was incrementally increased from 246 to 984. FIG. 15 shows that the two DBNC-CRP approaches outperforms CCRP and the number of source nodes does not affect the performance substantially.

A third experiment evaluated the effect of the number of destination nodes on the performance of the techniques. The number of source nodes and the number of items was fixed and the number of destination nodes was decreased. The experiment was done using networks of 246 source nodes that contained at least one item, 1,847 nodes for a circular source zone, and 766,123 items. FIG. 16 shows that as the number of destination nodes grows, the runtime decreases. As the number of destination nodes increases, the performance gap also increases.

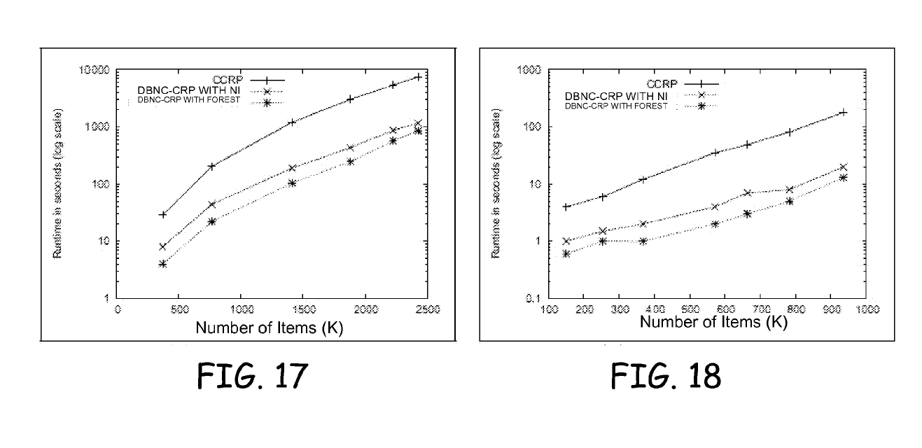

A fourth experiment evaluated scalability for large network datasets. The radius of the circular source zone was incrementally increased from 5 km to 30 km. FIG. 17 shows that the runtime of DBNC-CRP is scalable to the large network datasets due to the structure of networks to minimize the computational time. The results show that the runtime can be reduced by up to 80% without degrading the quality of solution compared to the CCRP algorithm A fifth experiment evaluated the effect of the shape of the source zone on the performance of the techniques. If the destination nodes are boundary nodes of the source zone, the circular source zone has the minimum number of boundary nodes due to the small surface for the source zone. If the source zone shows an irregular shape (e.g., coastal areas), the boundary nodes increase as the surface area of the source zone increases. In the experiment, a source zone along a river was chosen and the length of the non-circular source zone was incrementally increased to cover the entire river. FIG. 18 shows that the two DBNC-CRP approaches show better performance compared to the circular source zone in FIG. 17. This is because the number of boundary nodes of the irregular shaped source zone is greater than the circular source zone. Our results show that the runtime can be reduced by up to 90%.

Conveyance route planning for large networks is becoming increasingly important. An important component of conveyance planning methods is the ability to account for capacity constraints of the network with manageable computational cost. In some embodiments, the dartboard network structure reflects item flow patterns for common conveyance scenarios by exploiting the structure of the network. Based on the dartboard network structure, the DBNC-CRP embodiments described above partition the network using dartboard network cuts (DBN-cuts) and groups source nodes to maximize the number of items conveyed. Experimental evaluation of DBNC-CRP demonstrates significant improvements over previous work.

In addition to moving data packets, embodiments described above may be used in numerous areas including:

| | Description |
|---|---|
| Network Flow | |
| Problem | |
| Mass Evacuation | Moving people and data out of an evacuation |
| | zone to safe destinations as quickly as possible |
| Transportation | A Company manufactures its network cables at |
| schedules | different factories in the country. From these |
| | factories, the cables are transported to the |
| | cable depots, which are warehouses in different |
| | parts of the country. From the cable depots the |
| | cables are transported to the places where they |
| | are actually demanded. |
| Truck | A company has contracted to deliver perishable |
| Scheduling | goods between several different origin-destination |
| Problem | pairs. The customers have specified delivery dates |
| | when the shipments must reach their destinations. |
| | The company wants to determine the minimum time |
| | of ships needed to meet the delivery dates of the |
| | shiploads. |
| Scheduling | The scheduling problem is to determine a feasible |
| on Uniform | schedule that completes all jobs before their due |
| Parallel | dates or to show that no such schedule exists. |
| Machines | |
| Vehicle routing | Given a fleet of K capacitated vehicles domiciled |
| problem | at a common depot, a set of customer sites with a |
| | prescribed demand, and a cost of traveling for |
| | each road segment, what is the minimum cost set of |
| | routes for delivering the goods to the customer |
| | sites. |
| Optimal | A military commander has identified a set S of |
| Destruction of | military targets that he wants to destroy. He must |
| Military Targets | destroy bottle points to limit the movement of |
| | enemy. |
| Vulnerable | A cable network contains two points where two |
| Connections | campuses of university are located. Between these |
| | campuses there is a high level of communication |
| | that demands a lot of capacity of the cable |
| | system. A company needs to find the connection |
| | with an undesirable high utilization degree |
| | because these connections are the most vulnerable. |
| Bottleneck | |
| Transportation | |
| Problem | |
| Determining | If there are only minimal time lags between |
| Minimum Project | activities, that is, the project can be modeled by |
| Duration | an activity-on-arc network (or CPM network known |
| | from the ‘critical path method’) or an acyclic |
| | activity-on-node network, a large number of exact |
| | algorithms as well as heuristic procedures have |
| | been developed to solve the resource-constrained |
| | project-scheduling problem. |
| Warehouse | A warehouse is configured with docks for loading |
| layout | and unloading goods and with open areas for |
| | storing the goods. Trucks that deliver or pick up |
| | goods arrive at any one of the loading docks. The |
| | warehouse operators must collect or deliver the |
| | required items from their storage locations. |

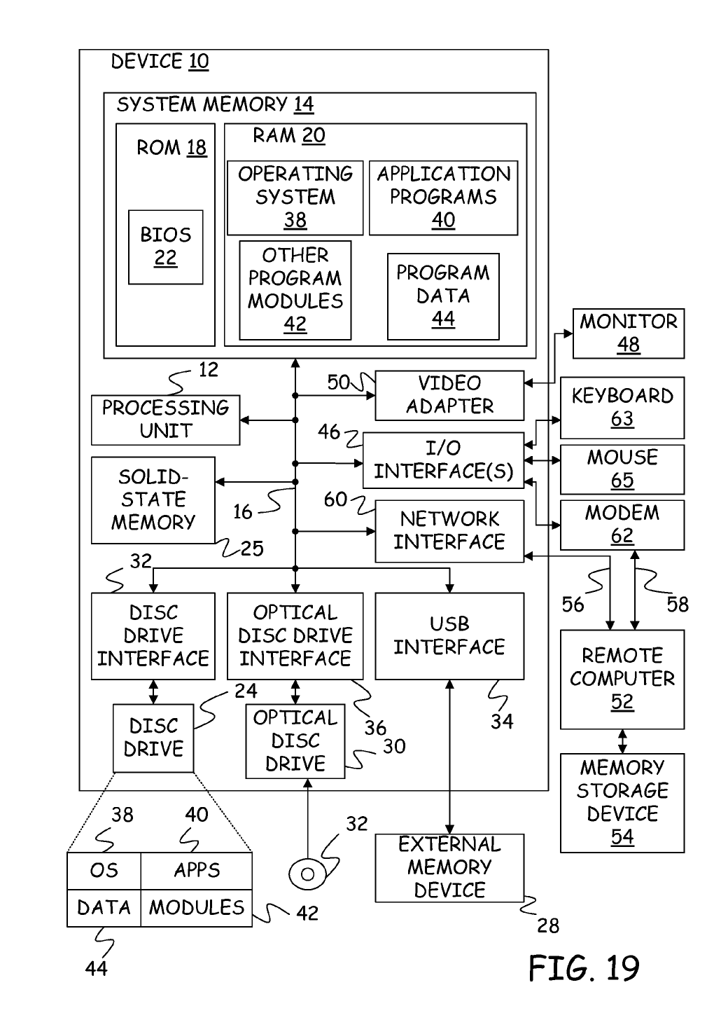

An example of a computing device that can be used as a server and/or client device in the various embodiments is shown in the block diagram of FIG. 19. The computing device 10 of FIG. 19 includes a processing unit or processor 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, a solid state memory 25, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives, solid-state memory and external memory devices and their associated computer-readable media provide nonvolatile computer-readable storage media for the computing device 10 on which computer-executable instructions and computer-readable data structures may be stored. These computer-executable instructions are executed by processing unit 12 to perform the functions described above. Other types of media that are readable by a computer may also be used in the exemplary operation environment.

A number of program modules may be stored in the drives, solid-state memory 25 and RAM 20, including an operating system 38, one or more application programs 40, other program modules 42 and program data 44. In particular, application programs 40 can include programs for executing the algorithms described above. Program data 44 may include network descriptions including paths between nodes, node capacities and edge or path capacities. Program data 44 may also include lists of source nodes, item distributions across source nodes, destination nodes, source zones, and sets of edges connecting nodes to form a network. Program data 44 also includes conveyance schedules and occupancy schedules as well as resulting conveyance plans.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 19. The network connections depicted in FIG. 19 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program, such as data stored in the databases or lists described above, may illustratively be stored within memory storage device 54. It will be appreciated that the network connections shown in FIG. 19 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
constructing a shortest forest of paths between a set of destination nodes and a set of source nodes, each path passing through a same number of intermediate nodes, wherein the constructing is performed by a processor;
selecting a set of node-independent paths from the shortest forest of paths such that no two node-independent paths pass through a same node other than a source node or a destination node of the node-independent paths; and
using the node-independent paths to schedule movement of items from at least one source node in the set of source nodes to at least one destination node in the set of destination nodes.

2. The method of claim 1 wherein the set of source nodes and destination nodes comprise computing devices and the items comprise data packets.

3. The method of claim 1 wherein the paths comprise travel routes for people.

4. The method of claim 1 further comprising:
increasing the number of intermediate nodes by one to form a new number of intermediate nodes after scheduling movement of items from at least one source node in the set of source nodes to at least one destination node in the set of destination nodes;
constructing a second shortest forest of paths between the set of destination nodes and a second set of source nodes, each path passing through the new number of intermediate nodes;
selecting a second set of node-independent paths from the second shortest forest of paths, such that no two node-independent paths in the second set of node-independent paths pass through a same intermediate node; and
using the second set of node-independent paths to schedule movement of items from at least one of the source nodes in the second set of source nodes to at least one destination node in the set of destination nodes.

5. The method 4 wherein each path has a limited capacity and wherein scheduling movement of items from at least one source node in the set of source nodes to at least one destination node comprises setting occupancy values for paths between the source nodes and the destination nodes at time frames.

6. The method of claim 5 wherein each path comprises a plurality of edges, each edge extending between two nodes and defined by a transit time required for items to traverse the edge, and wherein at least two edges have different transit times.

7. The method of claim 6 wherein selecting a second set of node independent paths comprises:
identifying at least two paths that pass through a common intermediate node;
determining total transit times along each path;
selecting the path with the lowest total transit time as a node-independent path and not selecting the other paths as node-independent paths.

8. The method of claim 7 wherein a total transit time for a path comprises a delay time for each node along the path and an edge transit time for each edge along the path, the delay time for a node comprising a length of time that an item must spend at a node before it may begin moving along the edge leaving the node.

9. A computer-readable storage medium having instructions stored thereon that when executed by a processor cause the processor to perform steps comprising:
identifying conveyance schedules for a set of edges to move items from source nodes to destination nodes by utilizing dartboard network rings.

10. The computer-readable storage medium of claim 9 wherein the source nodes comprise computing devices, the destination nodes comprise computing devices, and the edges comprise connections that link the source node computing devices to the destination node computing devices to allow data to move from the source node computing devices to the destination node computing devices.

11. The computer-readable storage medium of claim 9 wherein the edges comprise transportation paths and the items comprise people.

12. The computer-readable storage medium of claim 9 wherein the instructions for identifying conveyance schedules further comprise instructions for identifying conveyance schedules for items on source nodes in an outer ring of the dartboard network rings before identifying conveyance schedules for items on source nodes in an inner ring of the dartboard network rings.

13. The computer-readable storage medium of claim 12 wherein the instructions for identifying conveyance schedules further comprise instructions for identifying a forest of paths comprising paths from each source node in a ring of the dartboard network rings to at least one destination node, selecting node-independent paths from the forest of paths, and scheduling conveyance of items along the node-independent paths.

14. The computer-readable storage medium of claim 13 wherein the instructions for selecting node-independent paths from the forest of paths further comprise instructions for:
identifying intersecting paths in the forest of paths that share at least one intermediate node;
determining transit times along each intersecting path from a source node of the intersecting path to the destination node of the intersecting path; and
selecting the intersecting path with the shortest transit time as a node-independent path.

15. The computer-readable storage medium of claim 14 wherein the instructions for determining the transit time along an intersecting path further comprise instructions for adding the transit time of each edge along the path to delay times for each node along the path, wherein a delay time for a node comprises an amount of time an item spends at the node before it can leave the node.

16. The computer-readable storage medium of claim 15 wherein at least two edges have different transit times from each other.

17. A conveyance planning system comprising:
a processor capable of receiving information, the information defining:
a set of source nodes that form at least part of a source zone,
a distribution of items on the source nodes,
a set of safe nodes that are outside of the source zone, and
a set of edges, where each edge connects two respective nodes and conveys items between the two respective nodes;
wherein the processor is capable of calculating conveyance schedules to move one or more items from the source nodes to the safe nodes, each conveyance schedule indicating when items will be conveyed along the schedule's respective edge,
wherein the conveyance schedules are formed iteratively such that during each iteration, items scheduled for conveyance all originate at source nodes that are in a same dartboard network ring within the source zone.

18. The conveyance planning system of claim 17 wherein the items comprise computer data that is to be moved outside the source zone.

19. The conveyance planning system of claim 18 wherein the nodes within the source zone comprise computing devices, the safe nodes comprise computing devices and the edges comprise communication paths.

20. The conveyance planning system of claim 17 wherein an iteration of forming conveyance schedules comprises identifying a forest of conveyance routes from source nodes within a same dartboard network ring to safe nodes, selecting node-independent conveyance routes from the forest of conveyance routes, and updating schedules for only those edges along the node-independent conveyance routes.

21. The conveyance planning system of claim 20 wherein selecting node-independent conveyance routes comprises identifying overlapping conveyance routes in the forest of conveyance routes wherein overlapping conveyance routes have at least one same intermediate node and selecting an overlapping conveyance route with a shortest conveyance time as a node-independent conveyance route.
